(19) United States
(12) Patent Application Publication
(10) Pub. No.: US 2025/0282681 A1
(43) Pub. Date: Sep. 11, 2025

(54) BORIC ACID AS A CURING ADJUVANT IN A WARM BOX PROCESS

(71) Applicant: ASK Chemicals LLC, Wilmington, DE (US)

(72) Inventors: Michael Nocera, Powell, OH (US); Julen Bascaran, Columbus, OH (US)

(21) Appl. No.: 18/849,838

(22) PCT Filed: Mar. 17, 2023
(86) PCT No.: PCT/US23/15482

§ 371 Date: Sep. 23, 2024

Related U.S. Application Data
(60) Provisional application No. 63/322,403, filed on Mar. 22, 2022.

(51) Int. Cl. C04B 26/10; B22C 1/22; C04B 22/08; C04B 111/00; C08G 61/12

(52) U.S. Cl. CPC C04B 26/105; B22C 1/224; C04B 22/082; C08G 61/125; C04B 2111/00939; C08G 2261/3222; C08G 2261/42

(57) ABSTRACT

Boric acid is used as an adjuvant for the liquid catalyst used to cure furan-based binder systems for forming a foundry mold in a “warm box” process. The binder system comprises furfuryl alcohol, a furan resin, and a furan monomer or oligomer containing at least two terminal hydroxymethyl groups. The binder system also comprises a latent acid curing catalyst and the boric acid. The boric acid improves tensile strength of the foundry mix as well as through cure of the binder.

### CROSS-REFERENCE TO RELATED APPLICATIONS

This application is a national stage entry of PCT Application No. PCT/US23/15482, filed on 17 Mar. 2023, which claims priority to U.S. provisional patent application 63/322,403, filed on 22 Mar. 2022. Both PCT Application No. PCT/US23/15482 and U.S. provisional patent application 63/322,403 are incorporated by reference as if fully recited herein.

### TECHNICAL FIELD

This disclosure relates to the use of boric acid as an adjuvant for the liquid catalyst used to cure a furan binder system for forming a foundry mold in a warm box process.

### BACKGROUND ART

Within the foundry industry one of the most popular methods of sand casting for the production of foundry molds is the “no-bake” process. Primarily within this process, the use of phenolic resins has become increasingly popular due to their high tensile strength, and high tunability and control of the ratio of work time to strip time.

In the “no-bake” process, a foundry mix is prepared by mixing an appropriate aggregate with the binder and a curing catalyst. After forcing the foundry mix into a pattern, the curing of the foundry mix provides a foundry shape useful as a mold or core. In a “cold box” process, a foundry mix is prepared by mixing an appropriate aggregate with a binder. After forcing the foundry mix into a pattern, a catalyst vapor is passed through the foundry mix, causing it to cure and provide a foundry shape useful as a mold or core. However, in other processes, namely, the “warm-box” and “hot-box” processes, the foundry mix is prepared by mixing the aggregate with a heat reactive binder and catalyst. The foundry mix is shaped by forcing it into a heated pattern that causes the foundry mix to cure, providing a foundry shape useful as a mold or core.

While tuning the capabilities of a binder, such as a phenolic resin binder, is a desirable goal, an even more desirable goal exists for a tunable furan-based binder system. This is because furan, which is derived from lignocellulosic biomass, is an important renewable non-petroleum-based feedstock. It is also because furan-based binders provide additional benefits, due to the manner in which they are cured.

Even more important than work time and strip time are the tensile strength and the heat resistance of the molds. A high tensile strength allows the foundry mold to be handled and moved without permanent deformation, which would affect the casting shape. Heat resistance refers to the requirement that the foundry mold is able to reasonably withstand the heat transferred by the molten metal during casting, so that the process results in a product having the correct shape.

It is generally known that heating the sand molds can improve cure time and that tensile strength can be improved. In the procedure mentioned above as “warm-box,” the mold is heated to a temperature in the range of between 204° C. and 260° C., which is seen to dramatically accelerate the curing reaction. The “hot-box” process operates at higher temperatures. When using one of processes where the molds are heated, the heating time is generally referred to as “dwell time”.

As with any binder, the furfuryl alcohol (“FA”) binders have both advantages and disadvantages. It is always a desirable goal to provide improved binders possessing the advantages, while addressing the known disadvantages.

It is therefore an object of this invention to provide an improved binder for use in producing foundry shapes that provide as many of the advantages as possible of the known FA based binders, while minimizing or, preferably, eliminating, the known disadvantages.

### SUMMARY

This and other objectives are achieved by the features described below.

In some instances, the objectives are met by a binder system for use in a “warm-box” process. The binder system has a binder comprising furfuryl alcohol, a furan resin, and a furan monomer or oligomer containing at least two terminal hydroxymethyl groups. A latent acid curing catalyst is used to cure the binder, and an effective amount of boric acid is included in the binder system.

In many embodiments, the latent acid curing catalyst is provided in aqueous solution, separate from the furan binder, and the boric acid is dissolved in the aqueous solution.

The binder system preferably has the boric acid present in the range of from about 0.10 wt % to about 0.50 wt %, based on the binder.

For the “warm-box” process, it is preferred to provide a strong organic acid as the latent acid curing catalyst. In such systems, it is preferred to have the latent acid curing catalyst present in the range of from about 10 wt % to about 40 wt %, based on the binder, and, even more preferably, present at about 21 wt %, based on the binder.

Some aspects of the inventive concept are provided by a foundry mix that comprises the binder system described above, with a major amount of a foundry aggregate. In such a foundry mix, the binder of the binder system is preferably present in the range of from about 1 wt % to about 5 wt %, based on the foundry aggregate.

Other aspects of the inventive concept are provided by a method for preparing a foundry shape. Such a process comprises the steps of:
activating a curing property of the foundry mix by mixing the binder system with the foundry aggregate;
working the activated foundry mix in a mold or pattern to form a foundry shape;
exposing the foundry shape in the mold or pattern to a temperature in the range of from 204° C. to 260° C. for a dwell time sufficient to cure the foundry shape; and
removing the cured foundry shape from the mold or pattern.

Still further aspects of the inventive concept are achieved by a foundry shape prepared by this method.

Yet further aspects of the inventive concept are achieved by a metal casting prepared by the steps of:
pouring molten metal into a foundry shape as described above;
allowing the molten metal to cool and solidify; and
separating the metal casting from the foundry shape.

### BRIEF DESCRIPTION OF THE FIGURES

Certain aspects of the inventive concept will be better understood when reference is made to the accompanying photos, wherein identical parts are identified with identical reference numbers and wherein:

FIGS. 1A and 1B show perspective views of a formed cube, in upright and inverted positions, as described in the through-cure experiment; and

FIG. 2 shows a perspective view of a wall thickness measurement of the formed cube.

### DETAILED DESCRIPTION

The effects of boric acid on the cure of a furan-based binder in a warm-box procedure was tested. To minimize the changes in currently-practiced procedure, the experimental procedures used were kept similar.

The CHEM-REZ™ line of binder systems from ASK Chemicals LLC are considered a preferred product in the industry for making large castings, a few examples of which would include, for illustrative purposes only, machine tool bases, windmill components and power generation.

The binder system selected for experimentation was the CHEM-REZ WB 975 RESIN and the CHEM-REZ FC521 CATALYST, both of which are commercially available from ASK Chemicals LLC. A general understanding of this type of binder may be found at U.S. Pat. No. 7,125,914 to Chang, where it is disclosed that the binder is used to prepare foundry shapes, such as molds and cores, by mixing a minor amount of the binder with a major amount of foundry aggregate and a catalytical amount of a latent acid curing catalyst to form a foundry mix. The foundry mix is used to prepare foundry shapes. Once formed into foundry shapes, the combination of the curing catalyst, preferably copper tosylate, with temperature in the range of from about 100° C. to about 300° C. (212° F. to 572° F.) provides the cured foundry shape. The temperature may be applied by radiant heat or by microwave. The warm-box binder system comprised a binder with furfuryl alcohol, a furan resin, and a furan monomer or oligomer containing at least two terminal hydroxymethyl groups. The CHEM-REZ WB 975 RESIN is provided and used in the liquid phase. The catalyst used for the experiments was the commercially-available CHEM-REZ FC521 CATALYST, which contains an organic acid. It is provided and used in the liquid phase. As noted in U.S. Pat. No. 7,125,914 to Chang, any salt of a strong inorganic or organic acid, typically an acid having a pH<2, may be generally used as the curing catalyst. Examples of salts of inorganic acids, which can be used, are ammonium chloride, ammonium sulfate, ammonium nitrate, aluminum perchlorate, cupric perchlorate, and chromic perchlorate. Examples of salts from organic acids include copper phenol sulfonate, aluminum toluene sulfonate, zinc phenol sulfonate, and copper tosylate, and the like, most preferably copper toluene sulfonate. When a warm-box process is being used, the preference may be to use a strong organic acid. The amount of curing catalyst used is the amount required to result in foundry shapes, which can be handled without breaking. Generally, this amount is from 1 part to 45 parts by weight, preferably from 10 parts by weight to 40 parts by weight, most preferably 15 parts by weight to 35 parts by weight, based upon 100 parts binder.

In the experiments reported here, an amount of boric acid, B(OH)₃, was also provided to supplement the catalyst. In the laboratory experiments described here, the boric acid was used as a particulate solid that was dissolved in the catalyst at the time of being mixed with refractory sand. In commercial embodiments, it is anticipated that the boric acid would be added to the catalyst package provided to the customer, although it could be provided with the sand or as a part of the resin package.

For each experiment in this test, 48 parts by weight of the CHEM-REZ WB 975 RESIN furan binder was set aside for use.

To provide the refractory for each experiment, 4000 parts by weight of a BADGER®CAST FW-55 sand, commercially-available from Badger Mining Corp., was combined and mixed with 10.08 parts by weight of the CHEM-REZ FC521 CATALYST and the pre-selected amount of the boric acid. The 48 parts of CHEM-REZ WB 975 RESIN represented 1.2 wt %, based on sand (“BOS”), and was not varied across the experiment. The 10.08 parts of CHEM-REZ FC521 CATALYST represented 21 wt %, based on binder (“BOB”) and was also not varied across the experiment. In addition to a base case 1A, where no boric acid is added to the sand, three levels of boric acid addition were made: 0.168 parts by weight (case 1B), 0.336 parts by weight (case 1C) and 0.504 parts by weight (case 1D). When calculated as wt % BOB, these levels, respectively, are 0.35, 0.70 and 1.05, as seen in Table 1 below.

At this point, the 48 parts by weight of the furan binder were added to the sand, catalyst and boric acid and mixed to combine. Each mixture was forced by air-blowing into a multiple-mold dog bone pattern assembly that was heated to a fixed temperature of 232° C. (450° F.). Once in the mold, the mixture was held for a dwell time of either 15 or 20 seconds at the fixed temperature to allow the binder to cure. The shapes were then released from the pattern. For each case, the tensile strength of three bones was tested at 30 seconds after being removed from the warm box tool assembly. Three additional free-standing shapes were placed into a room at 21° C. and 70% relative humidity. These dog bone shapes were allowed to sit at the selected constant temperature and humidity for one hour before tensile strength testing. The results reported below in Table 1 are the averages of the three tensile strength bones broken for each case.

TABLE 1

| | 1A | 1B | 1C | 1D |
|---|---|---|---|---|
| WB 975 RESIN (wt % | 1.2 | 1.2 | 1.2 | 1.2 |
| BOS) | | | | |
| FC521 CATALYST (wt % | 21 | 21 | 21 | 21 |
| BOB) | | | | |
| B(OH)₃ (wt % | 0 | 0.35 | 0.70 | 1.05 |
| BOB) | | | | |
| TENSILE STRENGTH (psi) | | | | |
| 15 s Dwell @ 232° C. - 30 s | 147 | 171 | 174 | 166 |
| 15 s Dwell @ 232° C. - 1 h | 572 | 712 | 701 | 651 |
| 20 s Dwell @ 232° C. - 30 s | 149 | 181 | 178 | 176 |
| 20 s Dwell @ 232° C. - 1 h | 573 | 662 | 669 | 659 |

The results in Table 1 show that each of the cores produced from formulations containing boric acid exhibited higher tensile strength than the control case 1A. This strength is seen with both a “hot” core at 30 seconds after removal from the warm box as well as a “cold” core tested after 1 hour. The tensile strength increased by at least about 16% over the control for the “hot” cores, with similar numbers for the “cold” cores. The increase in tensile strength during the first hour, measured as a ratio of the tensile strength after 1 hour to the tensile strength after 30 seconds, shows a comparable increase. Two important observations are: 1) tensile strength appears to level off or even decrease after the addition of 0.35 wt % boric acid, when measured at 30 seconds or 1 hour; and 2) the difference between 15 or 20 seconds of dwell time at 232° C. would appear to be negligible. An optimal amount of boric acid may be in the 0.10 to 0.50 wt % range, based on binder.

Based upon the results of the first experiment, it was determined to quantitatively measure the effect, if any, of boric acid in increasing the overall amount of through cure or “depth” for the heat-cured furan resin binder system.

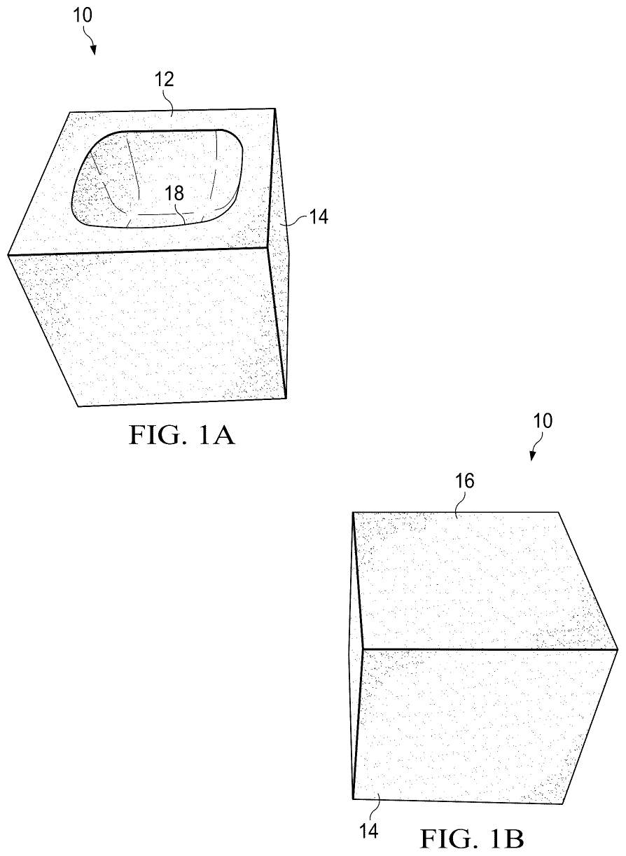

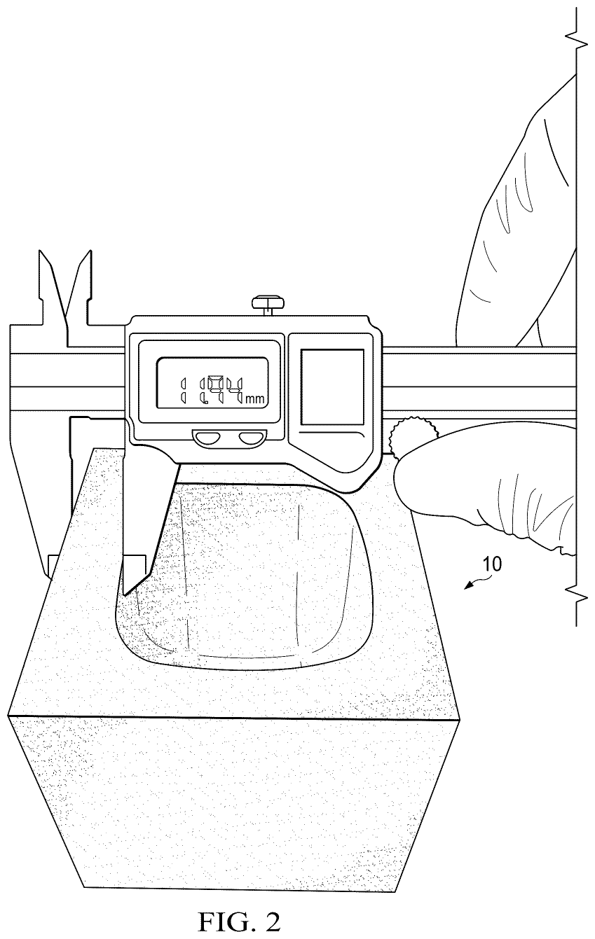

Instead of further testing with the “dogbone” mold, a cube mold was used. The mold has a solid bottom, four sides and an open top, through which molding mixture was air-blown. The cube mold has an edge size of 7.5 cm, so a nominal volume inside the cube is about 421 cm³. For each experiment, four of the cube molds were used. The filled cube mold was in each case held in the 232° C. heat source, but the dwell time was increased to 30 seconds, due to the different shape and volume of the mold. After the dwell time, the formed cube was removed from the cube mold, weighed and inverted to remove the uncured sand from the formed cube. Then the cured cube was re-weighed, so that the weight percentage of cured sand could be determined. Reference is made to FIGS. 1A and 1B, which are photos of a formed cube 10, in an upright position in FIGS. 1A and in an inverted position in FIG. 1B. Seen in these photos are top surface 12, side walls 14, bottom surface 16 and the cavity 18 created when the uncured sand is removed. FIG. 2 shows a measurement of wall thickness being made of the formed cube 10, using a caliper. For a given cube, it is desirable to take a measurement of the minimum thickness of each of the four side walls, so that an average thickness can be calculated. Typically, this minimum thickness will be observed to occur approximately halfway between the ends of the side wall. The percentage cured is the ratio of the weight of the cured sand to the total weight of sand charged to the cube mold.

For the cube mold experiment, sand was mixed with binder and catalyst in the same manner and proportion as in the first experiment, although the level of boric acid, based on binder, was 0.165 wt % in case 2B and was 0.33 wt % in case 2C. The control case, again designated here as 1A, contained no boric acid. In other words, it was equivalent to a state-of-the-art use of the particular binder system.

The formed cube was then weighed to determine the weight percentage of cured sand. The results are seen as Table 2.

TABLE 2

| | 1A | 2B | 2C |
|---|---|---|---|
| WB 975 RESIN (wt % | 1.2 | 1.2 | 1.2 |
| BOS) | | | |
| FC521 CATALYST (wt % | 21 | 21 | 21 |
| BOB) | | | |
| B(OH)₃ (wt % | 0 | 0.165 | 0.33 |
| BOB) | | | |
| CURED CUBES | | | |
| % Cure | 56.2 | 56.9 | 58 |
| Wall Thickness (mm) | 9.7 | 10.2 | 10.7 |

The results from the cube mold test suggests that the addition of boric acid improved the through-cure of the mold and resulted in higher weight percentages of cured sand. Here, higher amounts of boric acid added to the catalyst up to 0.33% resulted in increasingly better through-cure and higher weight percentages of cured sand.

In addition to weight percentage of cure, the wall thicknesses of the formed cubes, after removal of uncured sand, were measured to further gain insight into the through-cure of the binder sand. Results from this test indicated that addition of boric acid was not only not adverse, but that it improved through-cure of the mold over the entire range tested. For wall thickness, higher amounts of boric acid added to the catalyst up to 0.33% resulted increasingly better through-cure. Extrapolation from the dogbone test results might suggest that the effect may level off once the boric acid level goes beyond 0.50% or so. Also, it is important to note that the cube mold test is intended to provide a comparison basis against the base case. In forming commercial foundry shapes, it is the intention to cure substantially all of the sand. This test provides a good estimate of the “depth” of cure that may be obtained.

1. A binder system for use in a “warm-box” process, comprising:
a binder comprising furfuryl alcohol, a furan resin, and a furan monomer or oligomer containing at least two terminal hydroxymethyl groups;
a latent acid curing catalyst; and
boric acid present in the range from about 0.10 wt % to about 0.50 wt %, based on the binder.

2. The binder system of claim 1, wherein:
the latent acid curing catalyst is provided in aqueous solution; and
the boric acid is dissolved in the aqueous solution.

3. The binder system of claim 1, wherein the latent acid curing catalyst is a strong organic acid.

4. The binder system of claim 3, wherein the latent acid curing catalyst is present in the range of from about 10 wt % to about 40 wt %, based on the binder.

5. The binder system of claim 4, wherein the latent acid curing catalyst is present at about 21 wt %, based on the binder.

6. A foundry mix, comprising:
a major amount of a foundry aggregate; and
a binder system of claim 1.

7. The foundry mix of claim 6, wherein the binder of the binder system is present in the range of from about 1 wt % to about 5 wt %, based on the foundry aggregate.

8. A method for preparing a foundry shape, comprising the steps of:
activating a curing property of the foundry mix according to claim 6 by mixing the binder system with the foundry aggregate;
working the activated foundry mix in a mold or pattern to form a foundry shape;
exposing the foundry shape in the mold or pattern to a temperature in the range of from 204° C. to 260° C. for a dwell time sufficient to cure the foundry shape; and
removing the cured foundry shape from the mold or pattern.

9. A foundry shape prepared by the method of claim 8.

10. A metal casting prepared by the steps of:
pouring molten metal into a foundry shape of claim 9;
allowing the molten metal to cool and solidify; and
separating the metal casting from the foundry shape.
